(19) United States
(12) Patent Application Publication
(10) Pub. No.: US 2022/0108230 A1
(43) Pub. Date: Apr. 7, 2022

(54) APPARATUS FOR PROVIDING OF ARCHITECTURE VIDEO

(71) Applicant: HAAS STUDIO Co., Ltd., Seoul (KR)

(72) Inventor: Hyun Jung KIM, Seoul (KR)

(21) Appl. No.: 17/449,543

(22) Filed: Sep. 30, 2021

(30) Foreign Application Priority Data
Oct. 7, 2020 (KR) 10-2020-0129194

(51) Int. Cl. G06Q 10/02; G06K 9/00; G06Q 20/24; G06Q 20/34; G06Q 30/02

(52) U.S. Cl. CPC G06Q 10/02; G06K 9/00671; G06Q 30/0241; G06Q 20/34; G06Q 20/24

(57) ABSTRACT

An apparatus for providing an architecture video according to an embodiment of the present invention includes a video information management unit configured to manage video information for an architecture, a map management unit configured to map and manage location information of the architecture on an electronic map, a payment processing unit configured to activate the video information for which payment processing has been completed among a plurality of pieces of video information located within a preset range based on location information of a user, and an additional information management unit configured to output additional information including at least one of an advertisement, a game, a quiz, a questionnaire associated with the video information according to the location information of the user.

### CROSS-REFERENCE TO RELATED APPLICATION(S)

This application claims the benefit under 35 USC § 119(a) of Korean Patent Application No. 10-2020-0129194, filed on Oct. 7, 2020, in the Korean Intellectual Property Office, the entire disclosure of which is incorporated herein by reference for all purposes.

### BACKGROUND

### 1. Field

The present invention relates to an apparatus for providing an architecture video, and a technology for providing video content for urban architecture is disclosed.

### 2. Description of Related Art

As traveling abroad has been popular, the number of travels to visit famous foreign buildings is increasing. In Korea, mainly historical sites and tourist attractions have attracted domestic and foreign tourists. However, there are not many tourists visiting modern architectures. Even though architectures contain a variety of stories as they reflect the culture and history of a country, they are not being used as tourism content. Thus, there is a need for a technology for explaining and guiding urban architecture.

As one of related arts, Korean Patent No. 10-1946202 (registered on Jan. 30, 2019) relates to a user-participatory architecture information service platform server which includes an architecture information management unit configured to manage architecture information including at least one or more of the location, history, structure, use, and image of an architecture, an electronic map providing unit configured to map the architecture information and movement information included within a preset range based on location information of a user terminal on an electronic map and provide the electronic map, and a participation information management unit configured to receive participation information including at least one of the image, rating, and review of the architecture information from the user terminal and manage the received participation information.

However, according to the related art, participation is induced while receiving and sharing architecture photography information, which has limitations in providing content for guiding the architecture through video. In addition, there is a limitation in that the historical information on general architecture that is not a famous tourist spot cannot be utilized as a tourism product.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

One object to be achieved by the present invention is to provide an apparatus for providing an architecture video for developing tourism product content for an architecture that is not a tourist spot by enabling guidance on the architecture based on video information.

Another object is to provide an apparatus for providing an architecture video for matching a guide in an area of interest to provide easy explanation on surrounding architectures, history of neighborhoods, or the like to a user.

Yet another object is to provide an apparatus for providing an architecture video to enable the user to check congestion level information in advance before visiting an architecture and thereby sightsee the architecture without concern for congestion.

An apparatus for providing an architecture video according to an embodiment of the present invention includes a video information management unit configured to manage video information for an architecture, a map management unit configured to map and manage location information of the architecture on an electronic map, a payment processing unit configured to activate the video information for which payment processing has been completed among a plurality of pieces of video information located within a preset range based on location information of a user, and an additional information management unit configured to output additional information including at least one of an advertisement, a game, a quiz, a questionnaire associated with the video information according to the location information of the user.

In addition, the video information management unit may recognize a road sign when the road sign is photographed by the user terminal, and provide the video information for the architecture located in recognized road information.

In addition, the map management unit may further include a congestion level management unit configured to calculate congestion level information based on the number of people with respect to the area of the architecture and to display the congestion level information on the electronic map, and the payment processing unit may permit payment for a reservation for a visit to the architecture when the congestion level information is smaller than or equal to a preset value and may proceed to payment for the video information for the architecture when the congestion level information exceeds the preset value.

In addition, the apparatus for providing an architecture video may further include a matching unit configured to match the road information and a guide located within a preset distance when the road sign is recognized by the user terminal.

In addition, when identification code provided in the architecture is acquired from the user terminal at a first time point and then the identification code is acquired and verified at a second time point, the congestion level management unit may calculate the congestion level information by setting the time from the first time point to the second time point as the use time.

In addition, the matching unit may match a transportation means to the user and provide the video information through a display in the transportation means, and the payment processing unit may process a payment for the video information along with a transportation fee when the user terminates the use of the transportation means.

Other features and aspects will be apparent from the following detailed description, the drawings, and the claims.

### BRIEF DESCRIPTION OF THE DRAWINGS

FIG. 1 is a block diagram of an apparatus for providing an architecture video according to an embodiment of the present invention.

FIG. 2 is an exemplary diagram for explaining providing video information and an electronic map to a user terminal from the apparatus for providing an architecture video of FIG. 1.

FIG. 3 is an exemplary diagram for explaining receiving road information when a road sign is recognized by the user terminal in the apparatus for providing an architecture video of FIG. 1.

FIG. 4 is an exemplary diagram for explaining providing additional information to the user terminal from the apparatus for providing an architecture video of FIG. 1.

FIG. 5 is an exemplary diagram for explaining that identification code of an architecture is verified by the user terminal in the apparatus for providing an architecture video of FIG. 1.

FIG. 6 is an exemplary diagram for explaining matching a guide through the user terminal in the apparatus for providing an architecture video of FIG. 1.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Exemplary, non-limiting embodiments of the present invention will now be described more fully with reference to the accompanying drawings. Terms described in below are selected by considering functions in the embodiment and meanings may vary depending on, for example, a user or operator's intentions or customs. Therefore, in the following embodiments, when terms are specifically defined, the meanings of terms should be interpreted based on definitions, and otherwise, should be interpreted based on general meanings recognized by those skilled in the art.

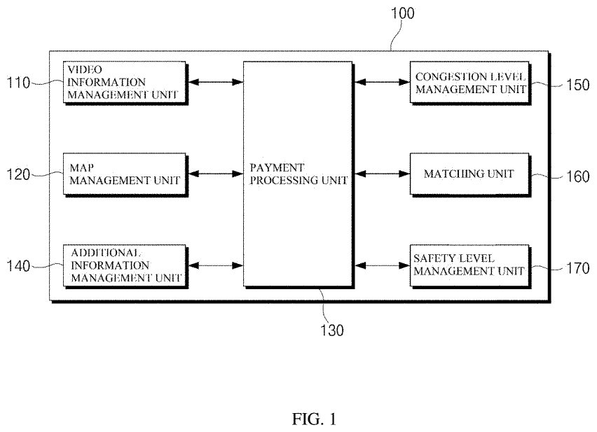

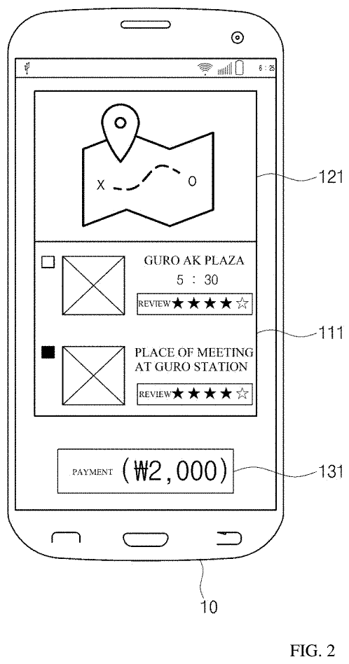

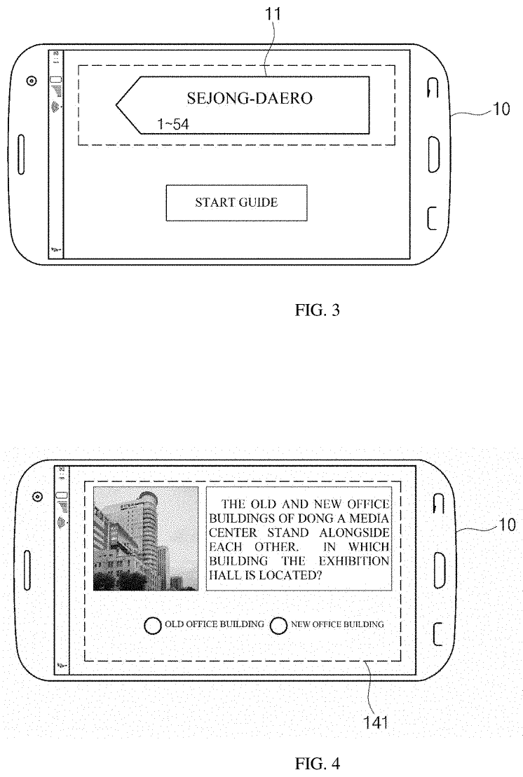

FIG. 1 is a block diagram of an apparatus for providing an architecture video according to an embodiment of the present invention, FIG. 2 is an exemplary diagram for explaining providing video information and an electronic map to a user terminal from the apparatus for providing an architecture video of FIG. 1, FIG. 3 is an exemplary diagram for explaining receiving road information when a road sign is recognized by the user terminal in the apparatus for providing an architecture video of FIG. 1, and FIG. 4 is an exemplary diagram for explaining providing additional information to the user terminal from the apparatus for providing an architecture video of FIG. 1.

Referring to FIGS. 1 to 4, an apparatus 100 for providing an architecture video according to an embodiment of the present invention may be implemented in a server fashion, or may be implemented by being installed in a user terminal 10 in the form of an application. More specifically, the apparatus 100 for providing an architecture video includes a video information management unit 110, a map management unit 120, a payment processing unit 130, and an additional information management unit 140.

The video information management unit 110 manages video information 111 regarding an architecture. For example, the video information 111 regarding an architecture may include a design and history of the architecture, an interview with an architecture owner, an interview with an architect, an interview with a user, reviews of other experts, and the like. The video information 111 is a video edited by a user and is reproduced for a predetermined period of time. The video information management unit 110 may acquire the video information 111 using a drone as well as a general camera. The video information 111 may be generated by imaging a plurality of photos of an architecture.

Also, the video information management unit 110 may be provided with the video information 111 from various users. In this case, the video information management unit 110 may determine whether pieces of video information 111 are redundant, so that only approved video information 111 is to be exposed. The video information management unit 110 may analyze voice information in the video information 111, and if expletives, profanity, commercial advertisement, and the like are included, may not expose them. The video information management unit 110 may additionally provide translated voice information or subtitles according to a language on the video information 111 and the language used by the user.

In addition, the video information management unit 110 may provide the video information 111 in a real-time streaming fashion. For example, when the video information 111 provided by a guide is received, it is possible to describe an architecture or surrounding facilities while capturing a video in real time. This is to allow a local guide to provide information on an architecture to the user in real time while directly capturing the video information 111, instead of the user. In this case, the video information management unit 110 may display the pre-captured video information 111 and the real-time video information 111 separately.

In addition, the video information management unit 110 may recognize a road sign 11 when the road sign 11 is photographed by the user terminal 10. In this case, the video information management unit 110 may recognize at least one of the shape, color, symbol, character, and figure of the road sign 11. The video information management unit 110 may provide video information 111 associated with road information. This is to provide the video information 111 according to the movement of the user. In this case, the road information may be displayed on an electronic map 121. When there is a plurality of pieces of video information 111 for the same architecture, the video information management unit 110 may rank the video information 111 according to the user's preference, such as the number of recommendations, the number of views, the number of payments, and the like, and provide the ranked video information.

The map management unit 120 maps and manages location information of an architecture on the electronic map 121. For example, the map management unit 120 may display an icon of the related video information 111 together with the location information of an architecture on the electronic map 121. The map management unit 120 may display an architecture for which the video information 111 exists using a symbol, a character, and a color so as to be identified on the electronic map 121. When the road information is additionally selected from the user's location information, the map management unit 120 may display the corresponding road information using a symbol, a character, a color line, and the like to be identified on the electronic map 121.

The payment processing unit 130 displays payment information 131 for a plurality of pieces of video information 111 located within a preset range based on the user's location information. The payment processing unit 130 activates the video information 111 for which payment processing has been completed. In this case, whether the video information 111 is free or charged is displayed, and even when it is free, the video information 111 can be reproduced only after formal payment processing is performed. The payment processing unit 130 may process payment by means of account transfer, a credit card, or points. The payment processing unit 130 processes a payment for the video information 111 selected by the user from among the plurality of pieces of video information 111.

In addition, when the payment is made with points, the payment processing unit may deduct points differentially according to the reproduction time ratio of the purchased video information 111. This is to allow the user to stop viewing the video information 111 when the video information 111 is not satisfactory, and to economically use points to make a payment only for the time of viewing. For example, when the price of ten-minute video information 111 is 1000 points, if the user watches for five minutes, only 500 points may be deducted. The payment processing unit 130 may provide the user terminal 10 with payment completion information through various forms, such as a text message, social media, e-mail, a push message, and the like.

Also, the payment processing unit 130 may also process a payment for a product of the architecture, or for a reservation for a visit to the architecture, in addition to the video information 111 regarding the architecture. For example, the payment processing unit 130 may discount the cost of a visit reservation or discount the purchase cost of a product when the video information 111 of the architecture is purchased. This is to induce a user with high interest in the architecture to directly visit the architecture, thereby gaining additional entrance revenue or product sales from the user. In this case, the payment processing unit 130 may also process the payment by selling the video information 111, the visit reservation, and the product purchase in the form of a package.

In addition, the payment processing unit 130 may adjust a reproducing time point of the image information 111 by using the reproduction time of the video information 111 and the location information of the user terminal 10. For example, when the reproduction of the video information 111 is requested, the payment processing unit 130 may set a reproducing time point according to the reproduction time of the video information 111 and the distance between the user terminal 10 and the architecture. In this case, when the walking distance between the user terminal 10 and the architecture is calculated as 10 minutes and the video reproduction time is 5 minutes, the image information 111 may be reproduced 5 minutes after the user moves. The payment processing unit 130 may reproduce the video information 111 when the user terminal 10 approaches the architecture within a preset distance.

In addition, the payment processing unit 130 may adjust the reproduction speed of the video information 111 by using the reproduction time of the video information 111 and the location information of the user terminal 10. For example, the payment processing unit 130 may reproduce the video information 111 by adjusting the reproduction speed of the video information 111 to be slower or faster than the basic reproduction speed by a preset value according to the moving speed of the user terminal 10. This is to allow the user to view the video information 111 for the architecture at an appropriate timing by adjusting the reproduction of the video information 111 by reflecting the time corresponding to the remaining distance to the architecture according to the user's moving speed.

In addition, the payment processing unit 130 may provide a movement path to the architecture, and when a safety caution area is included in the movement path, may stop the reproduction of the video information 111. In this case, the safety caution area may include a crosswalk, a narrow road, a lane, and the like. This is to prevent safety accidents from occurring when the user moves while viewing the video information 111. The payment processing unit 130 detects the location information of the user terminal 10 in real time and stops the reproduction of the video information 111 when the user terminal 10 approaches the safety caution area. In this case, the payment processing unit 130 may provide safety information, such as “Vehicles drive here. Please be careful,” through a speaker of the user terminal 10.

The additional information management unit 140 may output additional information 141 including at least one of an advertisement, a game, a quiz, and a questionnaire related to the video information 111 according to the user's location information. The additional information 141 may be included at various points in time, such as before reproduction, during reproduction, and after reproduction of the video information 111. For example, when the additional information 141 is advertisement information, advertisement information of a business place in the architecture of the video information 111 selected by the user may be provided. If the additional information 141 is a game, when the user terminal 10 is located near the corresponding architecture, a virtual object may be displayed and the user may obtain the virtual object. When the additional information 141 is a quiz, some content of the video information 111 may be provided as a quiz within a predetermined time after the video information 111 is reproduced.

Also, the additional information management unit 140 may pay a reward means according to the additional information 141 to a user account. For example, when an advertisement is viewed as the additional information 141 for more than a certain period of time, when a mission in the game is conducted, when a quiz is correctly answered, when a questionnaire is completed, or the like, various reward means, such as points, coupons, cyber money, etc., may be provided. Such a reward means may be used by the user to purchase the video information 111 or to use it as a cash substitute for purchasing and paying for goods or services in a store in an architecture. Accordingly, it is possible to increase the user's immersion in the video information 111 or to induce active participation

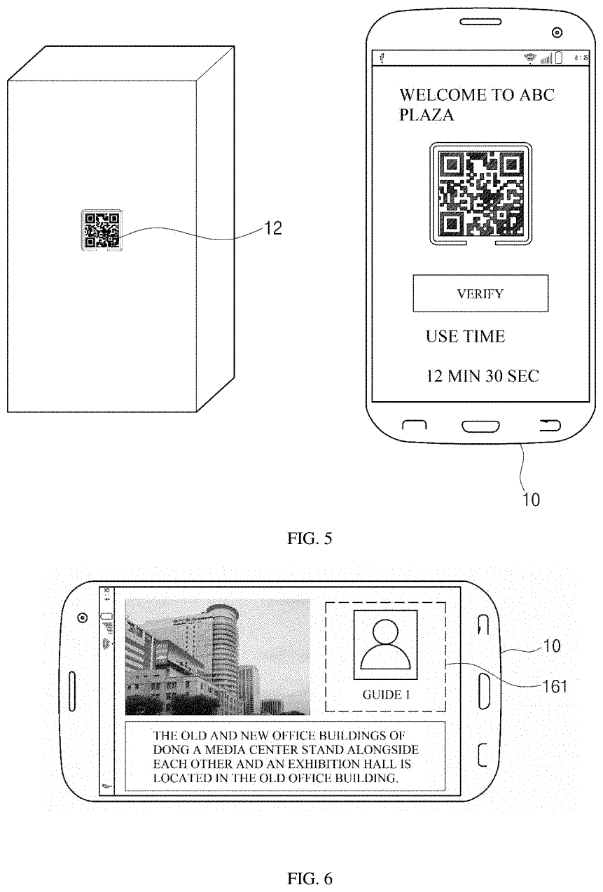

FIG. 5 is an exemplary diagram for explaining that identification code of an architecture is verified by the user terminal in the apparatus for providing an architecture video of FIG. 1.

Referring to FIG. 5, the apparatus 100 for providing an architecture video according to an embodiment of the present invention may further include a congestion level management unit 150. The congestion level management unit 150 may calculate congestion level information based on the number of people with respect to the area of the architecture and display the congestion level information on the electronic map 121. This is to inform in advance the user of the degree of congestion in the architecture when he or she wants to directly visit the architecture offline. In particular, this is to guide people to avoid highly congested architectures when an infectious disease such as coronavirus disease is prevalent. In this case, the congestion level information may be provided from the user terminal 10 or a manager terminal of the architecture.

For example, the congestion level management unit 150 may calculate the congestion level information using the identification code 12 provided inside the architecture. In this case, when the identification code 12 provided in the architecture is acquired from the user terminal 10 at a first time point and then the identification code 12 is acquired and verified at a second time point, the congestion level management unit 150 may set the time from the first time point to the second time point as the use time. This is to calculate the number of users at the same time by using the time for which visitors stay in the architecture. The congestion level management unit 150 calculates the congestion level information based on the number of users with respect to the area of the architecture. A state of the congestion level information may be displayed on the electronic map 121 using a numerical value or a color icon.

In this case, the payment processing unit 130 permits payment for reservation for visit to the architecture when the congestion level information is within a preset value. This is to allow a visit when the congestion level information is within a preset value, which is considered safe. Meanwhile, when the congestion level information exceeds the preset value, the payment processing unit 130 proceeds to payment for the video information 111 regarding the architecture. This is to provide only the video information 111 without allowing a visit when the congestion level information exceeds the preset value. Accordingly, the user can check the congestion level information in advance before visiting the architecture, so that the user can view the building without concern for congestion. In addition, even when it is difficult to sightsee the architecture, the video information 111 is provided, allowing the user to have an indirect experience.

FIG. 6 is an exemplary diagram for explaining matching a guide through the user terminal in the apparatus for providing an architecture video of FIG. 1.

Referring to FIGS. 1 to 6, the apparatus 100 for providing an architecture video according to an embodiment of the present invention may further include a matching unit 160. When the road sign 11 is recognized through the user terminal 10, the matching unit 160 matches the road information and a guide located within a preset distance. In this case, the guide may be matched online or offline to meet. For example, the matching unit 160 may provide matching information 161 online by guiding a video call between the user and the guide after matching the user and the guide. This is to allow the guide to easily explain the surrounding architectures or the history of the neighborhood while the current user is moving.

Also, the matching unit 160 may enable the guide to provide the video information 111 while moving along the road in a state in which the user does not move. This is to provide the video information 111 in real time so that the user can view the architecture even at home. The matching unit 160 may receive evaluation information on the guide from the user, and may receive evaluation information on the user from the guide.

In addition, the matching unit 160 may match and provide a means of transportation to the user. For example, a taxi may be reserved as a means of transportation in association with a taxi driver, and the video information 111 may be provided through a display in the means of transportation while the user is moving by the transportation means. In this case, when the user inputs his/her departure point and destination, a means of transportation to travel the corresponding distance is matched. The matching unit 160 may provide information on the driver and the cost of a fare differentially depending on whether video information is provided.

Meanwhile, the payment processing unit 130 may process a payment by including the usage fee for the video information in the transportation fee when the user terminates the use of the transportation means after viewing the video information 111 using the display installed in the transportation means. In addition, a driver him/herself may be matched as a guide and may provide information on an architecture. In this case, a predetermined reward means may be paid to the driver's account. Accordingly, the user may obtain information on the architecture while moving using the transportation means, and additional revenue may be generated for the driver.

Referring back to FIG. 1, the apparatus 100 for providing an architecture video according to an embodiment of the present invention may further include a safety level management unit 170. When the user visits an architecture and the identification code 12 provided in the architecture is recognized by the user terminal 10, the safety level management unit 170 obtains information on the user's disease history and transmits the same to an architecture manager. In this case, the safety management unit 170 may obtain the information on the disease history in connection with the Centers for Disease Control and Prevention. For example, whether a highly infectious disease such as coronavirus has been confirmed may be determined. This is to restrict the use of infectious users in the architecture and to accurately identify the movement path of the users.

Moreover, the safety level management unit 170 may generate safety level information based on environmental information in the architecture. This is to determine the safety level based on whether hazardous gases, such as particulate matter, carbon monoxide, carbon dioxide, etc. inside the architecture. When the safety level information in the architecture exceeds a preset value, the safety level management unit 170 may transmit risk information on the architecture to the user terminal 10. In this case, users with underlying disease, such as bronchial disease, may be able to protect their health by avoiding visiting a dangerous architecture.

Accordingly, the provision of guide on architecture based on video information is enabled, so that tourism product content for the architecture that is not a tourist spot can be developed.

In addition, a guide in an area of interest may be matched to easily explain the surrounding architectures and the history of the neighborhood to the user.

Moreover, a user can check in advance congestion level information before visiting an architecture, so that the user can sightsee the building without concern for congestion.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

### REFERENCE NUMERALS

10: USER TERMINAL
11: ROAD SIGN
12: IDENTIFICATION CODE
100: APPARATUS FOR PROVIDING ARCHITECTURE VIDEO
110: VIDEO INFORMATION MANAGEMENT UNIT
111: VIDEO INFORMATION
120: MAP MANAGEMENT UNIT
121: ELECTRONIC MAP
130: PAYMENT PROCESSING UNIT
131: PAYMENT INFORMATION
140: ADDITIONAL INFORMATION MANAGEMENT UNIT
141: ADDITIONAL INFORMATION
150: CONGESTION LEVEL MANAGEMENT UNIT
160: MATCHING UNIT
161: MATCHING INFORMATION
170: SAFETY LEVEL MANAGEMENT UNIT

What is claimed is:

1. An apparatus for providing an architecture video comprising:
a video information management unit configured to manage video information for an architecture;
a map management unit configured to map and manage location information of the architecture on an electronic map;
a payment processing unit configured to activate the video information for which payment processing has been completed among a plurality of pieces of video information located within a preset range based on location information of a user; and
an additional information management unit configured to output additional information including at least one of an advertisement, a game, a quiz, a questionnaire associated with the video information according to the location information of the user.

2. The apparatus of claim 1, wherein the video information management unit is configured to recognize a road sign when the road sign is photographed by the user terminal, and to provide the video information for the architecture located in recognized road information.

3. The apparatus of claim 1, wherein the map management unit further comprises a congestion level management unit configured to calculate congestion level information based on the number of people with respect to the area of the architecture and to display the congestion level information on the electronic map, and
the payment processing unit is configured to permit payment for a reservation for a visit to the architecture when the congestion level information is smaller than or equal to a preset value and to proceed to payment for the video information for the architecture when the congestion level information exceeds the preset value.

4. The apparatus of claim 2, further comprising a matching unit configured to match the road information and a guide located within a preset distance when the road sign is recognized by the user terminal.

5. The apparatus of claim 3, wherein, when identification code provided in the architecture acquired from the user terminal at a first time point and then the identification code is acquired and verified at a second time point, the congestion level management unit is configured to calculate the congestion level information by setting time from the first time point to the second time point as a use time.

6. The apparatus of claim 4, wherein the matching unit is configured to match a transportation means to the user and to provide the video information through a display in the transportation means, and
the payment processing unit is configured to process a payment for the video information along with a transportation fee when the user terminates the use of the transportation means.
